(19) United States
(12) Patent Application Publication
(10) Pub. No.: US 2006/0130155 A1
(43) Pub. Date: Jun. 15, 2006

(54) Method for verifying the validity of a day/date combination

(75) Inventors: Indran Naick, Cedar Park, TX (US); Jeffrey Kenneth Wilson, Austin, TX (US)

Correspondence Address: IBM CORPORATION (SWP);C/O SUITER WEST SWANTZ PC LLO, 14301 FNB PARKWAY, SUITE 220, OMAHA, NE, 68154-5299, US

(73) Assignee: INTERNATIONAL BUSINESS MACHINES CORPORATION, ARMONK, NY (US)

(21) Appl. No.: 11/010,131

(22) Filed: Dec. 10, 2004

(51) Int. Cl. G06F 17/30; H04L 9/00; G06F 7/04; G06K 9/00; H03M 1/68; H04K 1/00; H04L 9/32; H04N 7/16

(52) U.S. Cl. 726/30; 713/177

(57) ABSTRACT

The present invention is a method for verifying the validity of a day/date combination, which includes the steps of: detecting a day/date combination; verifying the validity of the day/date combination; and, notifying a user upon finding that the day/date combination is invalid.

### FIELD OF THE INVENTION

The present invention relates to the field of computing and particularly to a method and program for verifying the validity of a day/date combination.

### BACKGROUND OF THE INVENTION

Sometimes, when using a word processing application or when composing an e-mail, a user may need to include a day/date combination. For example, a user may enter a combination such as “Friday, Sep. 23, 2004.” Currently, the only way for a user to know if the combination is valid (i.e.—represents an accurate day/date combination) is to check a calendar.

Therefore, it would be advantageous to have a method and program for verifying the validity of a day/date combination, which notifies a user if the combination is invalid and provides an efficient way to correct the invalid combination.

### SUMMARY OF THE INVENTION

Accordingly, the present invention is directed to a method for verifying the validity of a day/date combination, which includes the steps of: detecting a day/date combination; verifying the validity of the day/date combination; and, notifying a user upon determining that the day/date combination is invalid.

A further embodiment of the present invention is directed to a method for verifying the validity of one or more day/date combinations, which includes the steps of: receiving a day/date combination query including one or more user-selected day/date combinations; verifying the validity of each user-selected day/date combination; and, notifying a user upon determining that one or more of the user-selected day/date combinations is invalid.

An additional embodiment of the present invention is directed to a method for verifying the validity of one or more day/date combinations, which includes the steps of: receiving a day/date combination query; verifying the validity of each day/date combination present within a designated portion of text; and, notifying a user upon finding that one or more of the day/date combinations is invalid.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is a flowchart illustrating a method for verifying the validity of a day/date combination in accordance with an exemplary embodiment of the present invention;

FIG. 2 is a flowchart illustrating a method for verifying the validity of one or more day/date combinations, wherein verification occurs upon receipt of a day/date combination query in which a user selects the combination(s) to be verified in accordance with an exemplary embodiment of the present invention; and,

FIG. 3 is a flowchart illustrating a method for verifying the validity of one or more day/date combinations, wherein verification occurs upon receipt of a day/date combination query and each combination present within a designated portion of text is automatically detected and verified during the verification step.

### DETAILED DESCRIPTION OF THE INVENTION

Reference will now be made in detail to the presently preferred embodiments of the invention, examples of which are illustrated in the accompanying drawings.

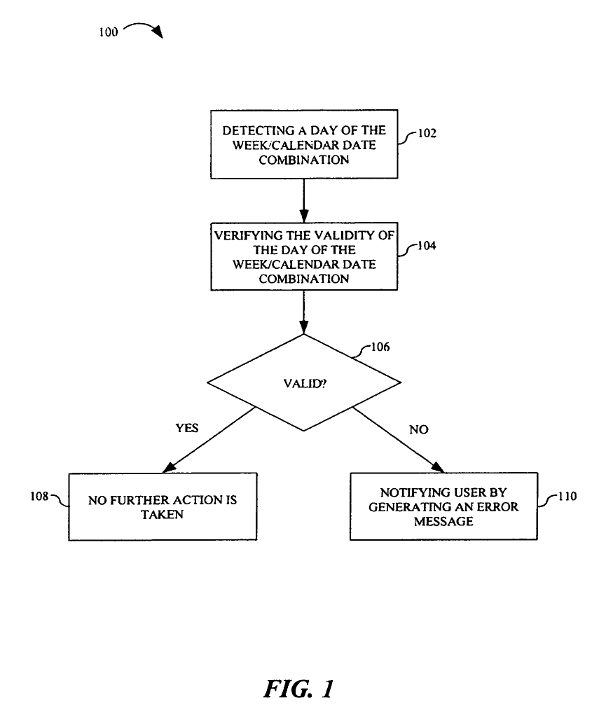

Referring generally to FIG. 1, a method for verifying the validity of a day/date combination 100 in accordance with an embodiment of the present invention is discussed. The method 100 includes detecting a day/date combination 102. In a present embodiment, a day/date combination in the form of text is entered or loaded into a computing device, such as a personal computer, a PDA, a cellular phone or the like. For example, a user composing a letter via a word processing or e-mail application on his or her personal computer may find it necessary to enter a day/date combination such as “Saturday, Mar. 17, 2001”, “Saturday, Mar. 17, 2001, “Saturday-17 Mar. 2001” or like variations thereof. In the present embodiment, an editor implemented within the computing device automatically detects the day/date combination 102 upon entry by the user.

The method 100 further includes verifying the validity of the day/date combination 104. In a present embodiment, once detection of a day/date combination has occurred, the editor verifies the validity of the day/date combination 104. In present embodiments, the editor is a parser, which performs the verification step by utilizing a lookup circuit, a hardware circuit or the like to check the combination against a data bank of valid day/date combinations. The editor will then proceed to determine if the combination is valid 106, if so, no further action is taken 108 and the user is never interrupted. However, if the combination is found to be invalid, the user will be notified by a corresponding error message 110. In a present embodiment, an error message is visibly displayed on a display of the computing device, the visible error message corresponding to the invalid combination and including a list of one or more correct day/date combinations from which the user can select to substitute for the invalid combination. For example, if the user entered “Friday, Aug. 5, 2004”, since no such combination exists, an error message may be displayed which asks the user whether he or she meant to enter “Friday, Aug. 6, 2004” or “Thursday, Aug. 5, 2004,” both of which are valid combinations. The user can then substitute, via keyboard or mouse entry, one of the displayed valid combinations for the invalid combination. The user may also enter a combination different from the displayed valid combinations included in the list, in which case, the newly entered combination is detected 102 and verified for validity 104. Once a valid combination has been substituted for the invalid combination, the editor allows the user to continue working and takes no further action, unless a subsequently entered day/date combination is detected, in which case, verification 104 is repeated.

In a further embodiment, if an incomplete combination is detected which excludes the year, such as “Thursday, September 2”, the combination will be verified as though it is for the current year at the time of verification. For example, if an editor implemented within a personal computer detects a combination that excludes the year, the editor will verify the combination as though it is for the year stored in an operating system program of the personal computer at the time of verification.

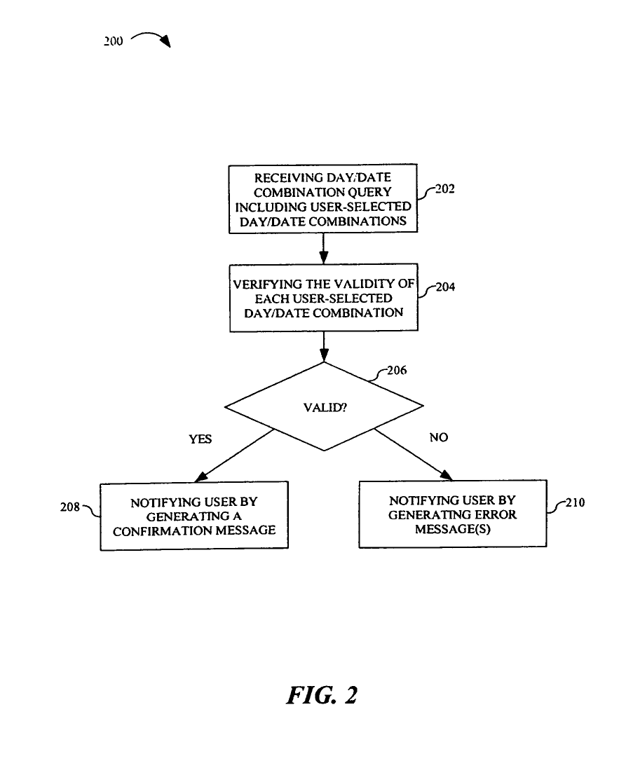

Referring generally to FIG. 2, a method for verifying the validity of one or more day/date combinations 200 in accordance with an embodiment of the present invention is discussed. The method 200 includes receiving a day/date combination query including one or more user-selected day/date combinations 202. In a present embodiment, a user enters or loads text into a computing device, the text including one or more day/date combinations. In further embodiments, the text is provided by a third party and loaded or entered into the computing device. In the present embodiment, an editor, implemented within the computing device, receives a day/date combination query from the user 202. The query is made in two steps. First, the user selects one or more day/date combinations within the text that he or she wants verified for validity. For example, if the user is operating a personal computer, selecting the combinations may be achieved by manipulating the computer's mouse or keyboard to highlight the desired combinations. In the second step, the user completes the query by entering or selecting a function associated with the editor. For instance, a user operating a personal computer can select a function associated with the editor from a dropdown menu by manipulating the computer's keyboard or mouse. The day/date combination query, including the user-selected day/date combinations, is then received.

The method 200 further includes verifying the validity of each user-selected day/date combination 204. In the present embodiment, the editor makes a determination as to whether each combination is valid 206. If the editor determines that each combination is valid, the user is notified by a confirmation message 208. In one embodiment, a visible confirmation message will appear containing text such as “No invalid combinations were found.” In a further embodiment, the confirmation message provides an audible indication that no invalid combinations were found. If, however, the editor determines that one or more combinations is invalid, the user is notified by one or more corresponding error messages 210. In a present embodiment, each error message is visible, corresponds to an invalid combination and includes a list of one or more valid day/date combinations from which the user can select to substitute for a corresponding invalid combination. In one embodiment, the error messages are displayed simultaneously. In further embodiments, the error messages are displayed subsequent to one another. For instance, if two invalid combinations are found, a first error message is displayed corresponding to the first invalid combination and including a list of valid substitute combinations. Once a user has substituted a valid combination for the first invalid combination, a second error message is displayed corresponding to the second invalid combination and including a list of valid substitute combinations. A user may then substitute a valid combination for the second invalid combination. After a valid combination has been substituted for each error message, the editor allows the user to continue working and takes no further action, unless a subsequent day/date combination query is received, in which case, verification 204 is repeated.

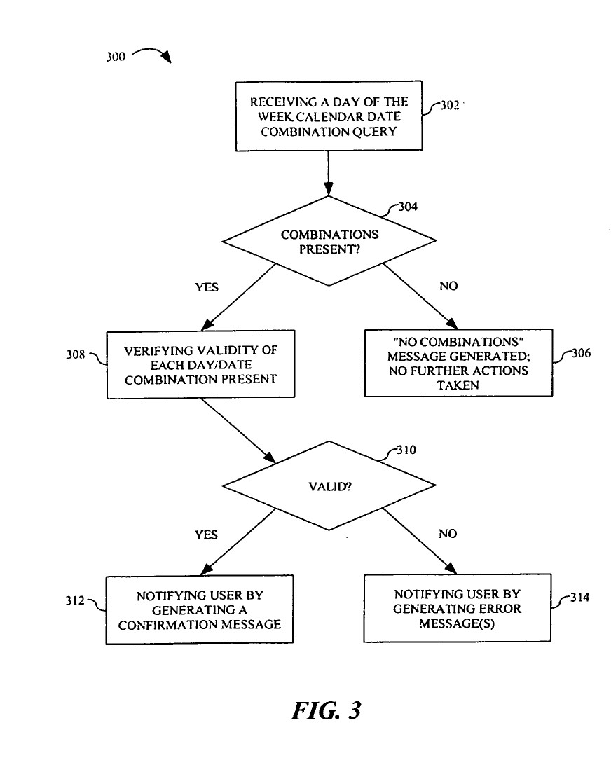

Referring generally to FIG. 3, a method for verifying the validity of one or more day/date combinations 300 in accordance with an embodiment of the present invention is discussed. The method 300 includes receiving a day/date combination query 302. In a present embodiment, a user enters or loads text into a computing device, the text including one or more day/date combinations. An editor, implemented within the computing device, then receives a day/date combination query from the user 302. In the present embodiment, the user makes the query 302 by entering or selecting a function associated with the editor.

The method 300 further includes verifying the validity of one or more day/date combinations 308. In the present embodiment, the editor performs the verification step 308 by automatically detecting and verifying each day/date combination present within a designated portion of text. For example, the editor may scan a letter composed using a word processing application to find all day/date combinations present 304. If no day/date combinations are present, a message indicating this fact to the user is generated 306 and the verification step does not occur. If one or more combinations are found, verification occurs 308 and the editor determines the validity of each combination 310. If the editor determines that each combination is valid, the user is notified by a confirmation message 312. However, if the editor determines that one or more combinations are invalid, the user is notified by one or more corresponding error messages 314. In the present embodiment, each error message is visible, corresponds to an invalid combination and includes a list of one or more valid day/date combinations from which the user can select to substitute for a corresponding invalid combination. After a valid combination has been substituted for each error message, the editor allows the user to continue working and takes no further action, unless a subsequent day/date combination query is received and one or more day/date combinations are present, in which case, verification 308 is repeated.

In further embodiments, the method further includes the editor being enabled or disabled. For example, a user may be able to enable or disable the editor on his or her computer as desired by manipulation or activation of a function.

It is important to note that while the present invention has been described as a method, those skilled in the art will appreciate that the method of the present invention is capable of being distributed in the form of a computer readable medium of instructions in a variety of forms, and that the present invention applies equally, regardless of -the particular type of signal bearing media utilized to carry out the distribution. Examples of computer readable media include: non-volatile, hard-coded type media such as read only memories (ROMs) or erasable, electrically programmable read only memories (EEPROMs), recordable-type media such as floppy disks, hard disk drives and CD-ROMs and transmission-type media such as digital and analog communication links.

It is believed that the method and program of the present invention and many of its attendant advantages will be understood by the forgoing description. It is also believed that it will be apparent that various changes may be made in the form, construction and arrangement of the steps or elements thereof without departing from the scope and spirit of the invention or without sacrificing all of its material advantages. The form herein before described being merely an explanatory embodiment thereof.

What is claimed is:

1. A method for verifying validity of a day/date combination, comprising:
detecting a day/date combination;
verifying validity of the day/date combination; and,
notifying a user upon determining that the day/date combination is invalid.

2. A method as claimed in claim 1, wherein the day/date combination is in the form of text.

3. A method as claimed in claim 2, wherein detection is automatically done upon entry of the day/date combination.

4. A method as claimed in claim 2, wherein verification occurs upon detection of the day/date combination.

5. A method as claimed in claim 2, wherein if the day/date combination is verified as invalid, notification of a user is achieved by a visible error message, the error message corresponding to the invalid combination and including a list of one or more valid day/date combinations from which a user can select to substitute for the invalid combination.

6. A method as claimed in claim 2, wherein if the day/date combination excludes the year, verification occurs as though the combination is for the current year at the time of verification.

7. A program within a computer readable medium for verifying validity of a day/date combination in the form of text entered or loaded into a computing device, comprising:
instructions within the computer readable medium for causing the device to detect a day/date combination;
instructions within the computer readable medium for causing the device to verify validity of the day/date combination; and,
instructions within the computer readable medium for causing the device to notify a user upon determining that the day/date combination is invalid.

8. A program as claimed in claim 7, wherein instructions are included within the computer readable medium which allow the device to automatically detect a day/date combination upon entry by a user.

9. A program as claimed in claim 7, wherein instructions are included within the computer readable medium which cause the device to begin verification upon detection of the day/date combination.

10. A program as claimed in claim 7, wherein the instructions within the computer readable medium for causing the computing device to notify a user include instructions which allow for a visible error message to be generated and displayed on a display of the device, the error message corresponding to the invalid combination and including a list of one or more valid day/date combinations from which a user can select to substitute for the invalid combination.

11. A program as claimed in claim 7, wherein instructions are included within the computer readable medium which cause the device, upon the device detecting a day/date combination with the year excluded, to verify the combination as though the combination is for the current year stored within the device at the time of verification.

12. A method for verifying validity of one or more day/date combinations, comprising:
receiving a day/date combination query;
verifying validity of each day/date combination found within the query; and,
notifying a user upon determining that one or more day/date combinations found within the query is invalid.

13. A method as claimed in claim 12, wherein each day/date combination is in the form of text.

14. A method as claimed in claim 13, wherein the day/date combination query is received by a computing device upon entry of a function.

15. A method as claimed in claim 14, wherein the day/date combination query is a request to verify one or more user-selected combinations.

16. A method as claimed in claim 14, wherein the day/date combination query is a request to locate and verify all day/date combinations present within a designated portion of text.

17. A method as claimed in claim 16, wherein if no day/date combinations are located, the user is notified by a confirmation message.

18. A method as claimed in claims 15 and 16, wherein if each combination is verified as valid, the user is notified by a confirmation message.

19. A method as claimed in claims 15 and 16, wherein if one or more combinations are verified as invalid, notification of the user is achieved by one or more error messages displayed on a display of the computing device, each error message corresponding to an invalid combination and including a list of one or more valid combinations from which a user can select to substitute for each corresponding invalid combination.

20. A method as claimed in claim 14, wherein if a day/date combination excludes the year, verification occurs as though the combination is for the current year stored within the computing device at the time of verification.
